(19) United States
(12) Patent Application Publication
(10) Pub. No.: US 2021/0206132 A1
(43) Pub. Date: Jul. 8, 2021

(54) POWDER MOLDING APPARATUS, POWDER MOLDING DIE, AND METHOD FOR PREPARING POWDER MOLDED BODY

(71) Applicant: KOBAYASHI INDUSTRY CO., LTD., Yurihonjo-City, Akita (JP)

(72) Inventor: Kiyomitsu Itou, Akita (JP)

(21) Appl. No.: 17/055,711

(22) PCT Filed: Jul. 30, 2019
(86) PCT No.: PCT/JP2019/029767

§ 371 Date: Nov. 16, 2020

(30) Foreign Application Priority Data
Jul. 31, 2018 (JP) 2018-143278
May 31, 2019 (JP) 2019-103185

(51) Int. Cl. B30B 11/00; B28B 3/02; B22F 3/03; B30B 11/02; B30B 15/02

(52) U.S. Cl. CPC B30B 11/007; B28B 3/02; B30B 15/022; B30B 11/02; B22F 3/03

(57) ABSTRACT

Each of a plurality of divided dies (11, 12) has a divided surface (111, 121) and a defining surface (112, 122) which defines a cavity 100. The divided surface has an inclined divided surface (1112, 1212) inclined with respect to the translational direction, and at least one pair of perpendicular divided surfaces (1112, 1113, 1211, 1213) which is disposed on the opposite side based on the defining surface and is perpendicular to the translational direction. Each of the plurality of divided dies (11) and (12), while abutting against each other at, at least the at least one pair of perpendicular divided surfaces of the divided surface, abuts against each other in a state of being spaced apart from each other with a gap d within a range of 1 to 30 μm at the inclined divided surface (1112, 1212), thereby forming the cavity 100.

### TECHNICAL FIELD

The present invention relates to a technique for preparing a powder molded body of metal, ceramics, or the like by using a die, and a technique for preparing a sintered body by sintering the powder molded body.

### BACKGROUND ART

A method has been proposed in which, when a powder molded body by a powder metallurgy method (hereinafter, sometimes simply referred to as a “powder molded body”) is prepared, the raw material powder is molded by using a die which is divided into two in the lateral direction or in the horizontal direction and whose divided surface is inclined with respect to the horizontal direction (see, for example, Patent Literature 1).

### CITATION LIST

### Patent Literature

Patent Literature 1: Japanese Patent No. 5261833

### SUMMARY OF INVENTION

### Technical Problem

However, when a plurality of divided dies is combined with each other to form a cavity, in a case where, after inclined divided surfaces forming divided surfaces of the respective divided dies abut against each other, each of the divided dies is still translatable, at least one of the plurality of divided dies may be displaced in a direction different from the translational direction in a manner of being guided by the inclined divided surface.

For example, a case will be considered in which, as shown in FIG. 25A, a die X0 is divided into two divided dies X1 and X2 in the lateral direction.

A divided surface X11 of the first divided die X1 is constituted by one pair of perpendicular divided surfaces X112 and X116 which is offset from each other in each of the lateral direction and the up-down direction and extends in the up-down direction, and an inclined divided surface X114 continuous with each of edges of the one pair of perpendicular divided surfaces X112 and X116. Similarly, a divided surface X21 of the second divided die X2 is constituted by one pair of perpendicular divided surfaces X212 and X216 which is offset from each other in each of the lateral direction and the up-down direction and extends in the up-down direction, and an inclined divided surface X214 continuous with each of edges of the one pair of perpendicular divided surfaces X212 and X216.

In this case, when, due to, for example, a preparing error of each of the divided dies, each of the divided dies X1 and X2 is driven in the lateral direction so as to approach each other, a situation may occur in which, while the inclined divided surfaces X114 and X214 abut against each other, the one pair of perpendicular divided surfaces X112 and X116 is still spaced apart from the one pair of perpendicular divided surfaces X212 and X216 respectively, as shown in FIG. 25A. In this situation, since each of the divided dies X1 and X2 may still be driven in the same direction, one divided die X1, though slightly, translates upward (lifts) so as to be guided by the inclined divided surface of the other divided die X2, as shown in FIG. 25B. This may result in an unexpected reduction in molding accuracy of the powder molded body.

Furthermore, another case will be considered in which, as shown in FIG. 26A, the die X0 is divided into two divided dies X1 and X2 in the lateral direction.

As shown in FIG. 26A, a defining surface X12 of the first divided die X1 is constituted by a first defining surface X121 substantially perpendicular to the translational direction, and a second defining surface X122 continuous with one side edge of the first defining surface X121 at one side edge and substantially parallel to the translational direction. The first divided surface X11 of the first divided die X1 is constituted by an inclined divided surface continuous with a different side edge of the first defining surface X121 and inclined with respect to the translational direction. A second divided surface X13 of the first divided die X1 is constituted by an inclined divided surface continuous with a different side edge of the second defining surface X122 and inclined with respect to the translational direction.

Similarly, as shown in FIG. 26A, a defining surface X22 of the second divided die X2 is constituted by a first defining surface X221 substantially perpendicular to the translational direction, and a second defining surface X222 continuous with one side edge of the first defining surface X221 a one side edge and substantially parallel to the translational direction. The first divided surface X21 of the second divided die X2 is constituted by an inclined divided surface continuous with a different side edge of the second defining surface X222 and inclined with respect to the translational direction. A second divided surface X23 of the second divided die X2 is constituted by an inclined divided surface continuous with a different side edge of the first defining surface X221 and inclined with respect to the translational direction.

In this case, when, due to, for example, a preparing error of each of the divided dies, each of the divided dies X1 and X2 is driven in the lateral direction so as to approach each other, after the divided surfaces X11 and X21 abut against each other and the divided surfaces X13 and X23 abut against each other, each of the divided dies X1 and X2 may be driven in the same direction. Thus, as shown in FIG. 26B, one divided die X1, though slightly, translates in a direction perpendicular to the translational direction so as to be guided by the inclined divided surface of the other divided die X2. This may result in an unacceptable reduction in molding accuracy of the insert.

Accordingly, the present invention has an object to provide, for example, a method which can improve molding accuracy of a powder molded body and a sintered body by preventing relative translation between divided dies in a direction different from the inherent translational direction, which is derived from an inclined divided surface forming a divided surface of each of the divided dies.

### Solution to Problem

The present invention relates to a powder molding apparatus comprising a plurality of divided dies which abuts against each other, thereby forming a cavity according to a shape of a side surface of a powder molded body, a die drive mechanism which relatively translates the plurality of divided dies, an upper punch and a lower punch which are inserted from an upper direction and a lower direction respectively into the cavity formed by the plurality of divided dies, and a lifting and lowering drive mechanism which lifts and lowers each of the upper punch and the lower punch, wherein each of the plurality of divided dies has a defining surface which defines the cavity, and a divided surface, in which the divided surface has a designated divided surface constituted by at least one of an inclined divided surface inclined with respect to a translational direction of each of the plurality of divided dies and a parallel divided surface parallel to the translational direction, and at least one pair of perpendicular divided surfaces disposed on an opposite side based on the defining surface, in which the at least one pair of perpendicular divided surfaces is perpendicular to the translational direction.

The powder molding apparatus of the present invention is configured so that each of the plurality of divided dies, while abutting against each other at the at least one pair of perpendicular divided surfaces of the divided surface, abuts against each other in a state of being spaced apart from each other with a gap within a range of 1 to 30 μm at the designated divided surface, thereby forming the cavity.

According to the powder molding apparatus with the configuration, when the cavity is formed, the at least one pair of perpendicular divided surfaces forming the divided surface of each of the divided dies abuts against the at least one pair of perpendicular divided surfaces forming the divided surface of each of the divided dies. Meanwhile, the designated divided surfaces forming the divided surfaces of the respective divided dies are spaced apart from each other with a gap. A part of the perpendicular divided surface of a plurality of the perpendicular divided surfaces forming the individual divided surface of each of the divided dies may be configured so as not to abut against the other perpendicular divided surface and may form a part of the designated divided surface.

Thus, while the plurality of divided dies abuts against each other at the designated. divided surfaces forming the divided surfaces thereof, a situation is reliably avoided in which the plurality of divided dies is still driven so as to relatively translate. Furthermore, the gap (or clearance) between the designated divided surfaces is within the range of 1 to 30 μm, and a situation is suppressed in which a raw material powder having an average particle size equal to or larger than the gap protrudes from the cavity into the gap. Thereby, relative translation (displacement) of the plurality of divided dies in a direction different from the inherent translational direction, which is derived from appearance of the situation, is reliably prevented from occurring, and molding accuracy of the cavity and consequently shape accuracy of the powder molded body are improved.

For the same reason, a method for preparing a powder molded body according to the present invention and a die having a plurality of divided dies according to the present invention can improve shape accuracy of the powder molded body.

In the powder molding apparatus of the present invention, it is preferable that the powder molding apparatus further comprises a gas supply device and that at least one divided die of the plurality of divided dies has a ventilation passage which supplies gas supplied from the gas supply device, to an outside of the at least one divided die through an opening of the divided surface.

According to the powder molding apparatus with the configuration, in a state where each of the plurality of divided dies is spaced apart from each other at the at least one pair of perpendicular divided surfaces forming the divided surface, the gas can be supplied to a gap between the divided surfaces. Thus, a raw material powder or dust or the like which is present in a gap between the perpendicular divided surfaces forming the divided surfaces is removed by the gas flow, and the perpendicular divided surfaces can reliably abut against each other with no raw material powder being caught. Thereby, the molding accuracy of the cavity and consequently the shape accuracy of the powder molded body are further improved. Further the gas can be supplied to the gap between the designated divided surfaces forming the divided surfaces of the plurality of respective divided dies. Thus, a raw material powder present in the gap between the designated divided surfaces forming the divided surfaces is removed by the gas flow. Thereby, while a workload for removing, from the powder molded body or a sintered body, a burr derived from the raw material powder present in the gap between the designated divided surfaces is reduced, the shape accuracy of the powder molded body is further improved.

In the powder molding apparatus of the present invention, it is preferable that the opening of the ventilation passage is provided at the designated divided surface forming the divided surface.

According to the powder molding apparatus with the configuration, in a state where each of the plurality of divided dies abuts against each other at the at least one pair of perpendicular divided surfaces forming the divided surface, the gas can be supplied to the gap between the designated divided surfaces forming the divided surfaces. Thus, after the plurality of divided dies abuts against each other and thereby the cavity is formed, a raw material powder protruding from the cavity to the gap is removed by the gas flow. Thereby, while a workload for removing, from the powder molded body or a sintered body, a burr derived from the protruding raw material powder is reduced, the shape accuracy of the powder molded body is further improved.

### BRIEF DESCRIPTION OF DRAWINGS

FIG. 1 is an explanatory view relating to a configuration of a die as a first embodiment of the present invention.

FIG. 2 is an explanatory view relating to a function of the die as the first embodiment of the present invention.

FIG. 3 is an explanatory view relating to a configuration of a die as a second embodiment of the present invention.

FIG. 4 is an explanatory view relating to a function of the die as the second embodiment of the present invention.

FIG. 5 is an explanatory view relating to a configuration of a die as a third embodiment of the present invention.

FIG. 6 is an explanatory view relating to a function of the die as the third embodiment of the present invention.

FIG. 7 is an explanatory view relating to a configuration of a die as a fourth embodiment of the present invention.

FIG. 8A is an explanatory view relating to a function of the die as the fourth embodiment of the present invention.

FIG. 8B is an explanatory view relating to a function of the die as the fourth embodiment of the present invention.

FIG. 9 is an explanatory view relating to a configuration of a die as a fifth embodiment of the present invention.

FIG. 10 is an explanatory view relating to a configuration of a die as a sixth embodiment of the present invention.

FIG. 11 is an explanatory view relating to a configuration of a die as a seventh embodiment of the present invention.

FIG. 12 is an explanatory view relating to a configuration of a die as an eighth embodiment of the present invention.

FIG. 13 is an explanatory view relating to a configuration of a die as a ninth embodiment of the present invention.

FIG. 14 is an explanatory view relating to a configuration of a powder molding apparatus as the first embodiment of the present invention.

FIG. 15 is an explanatory view relating to a configuration of a powder molding apparatus as the second embodiment of the present invention.

FIG. 16 is an explanatory view relating to a configuration of a powder molding apparatus as the third embodiment of the present invention.

FIG. 17A is an explanatory view relating to a method for preparing a molded body as the first embodiment of the present invention.

FIG. 17B is an explanatory view relating to the method for preparing a molded body as the first embodiment of the present invention.

FIG. 17C is an explanatory view relating to the method for preparing a molded body as the first embodiment of the present invention.

FIG. 17D is an explanatory view relating to the method for preparing a molded body as the first embodiment of the present invention.

FIG. 17E is an explanatory view relating to the method for preparing a molded body as the first embodiment of the present invention.

FIG. 18A is an explanatory view relating to a method for preparing a molded body as tire second embodiment of the present invention,

FIG. 18B is an explanatory view relating to the method for preparing a molded body as the second embodiment of the present invention.

FIG. 18C is an explanatory view relating to the method for preparing a molded body as the second embodiment of the present invention.

FIG. 18D is an explanatory view relating to the method for preparing a molded body as the second embodiment of the present invention.

FIG. 18E is an explanatory view relating to the method for preparing a molded body as the second embodiment of the present invention.

FIG. 19A is an explanatory view relating to a method for preparing a powder molded body as the third embodiment of the present invention.

FIG. 19B is an explanatory view relating to the method for preparing a powder molded body as the third embodiment of the present invention.

FIG. 19C is an explanatory view relating to the method for preparing a powder molded body as the third embodiment of the present invention.

FIG. 19D is an explanatory view relating to the method for preparing a powder molded body as the third embodiment of the present invention.

FIG. 19E is an explanatory view relating to the method for preparing a powder molded body as the third embodiment of the present invention.

FIG. 19F is an explanatory view relating to the method for preparing a powder molded body as the third embodiment of the present invention.

FIG. 20A is an explanatory view relating to a method for preparing a powder molded body as the fourth embodiment of the present invention.

FIG. 20B is an explanatory view relating to the method for preparing a powder molded body as the fourth embodiment of the present invention.

FIG. 20C is an explanatory view relating to the method for preparing a powder molded body as the fourth embodiment of the present invention.

FIG. 20D is an explanatory view relating to the method for preparing a powder molded body as the fourth embodiment of the present invention.

FIG. 20E is an explanatory view relating to the method for preparing a powder molded body as the fourth embodiment of the present invention.

FIG. 20F is an explanatory view relating to the method for preparing a powder molded. body as the fourth embodiment of the present invention.

FIG. 21A is a perspective view of a powder molded body as an example.

FIG. 21B is an upper view of the powder molded body as an example.

FIG. 21C is a side view of the powder molded body as an example.

FIG. 22 is an explanatory view relating to a configuration of a die as a modified embodiment of the first embodiment of the present invention.

FIG. 23 is an explanatory view relating to a configuration of a die as a modified embodiment of the first embodiment of the present invention.

FIG. 24 is an explanatory view relating to a configuration of a die as another embodiment of the present invention.

FIG. 25A is an explanatory view relating to a configuration of a die in a first related art.

FIG. 25B is an explanatory view relating to a function of the die in the first related art.

FIG. 26A is an explanatory view relating to a configuration of a die in a second related art.

FIG. 26B is an explanatory view relating to a function of the die in the second related art.

### DESCRIPTION OF EMBODIMENTS

### Configuration of Die (First Embodiment)

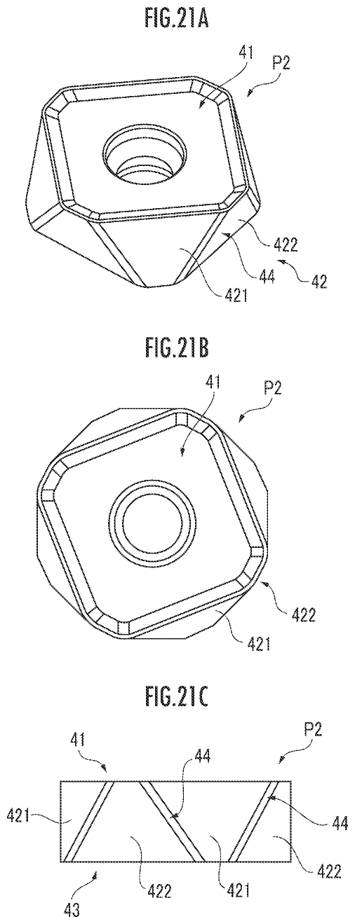

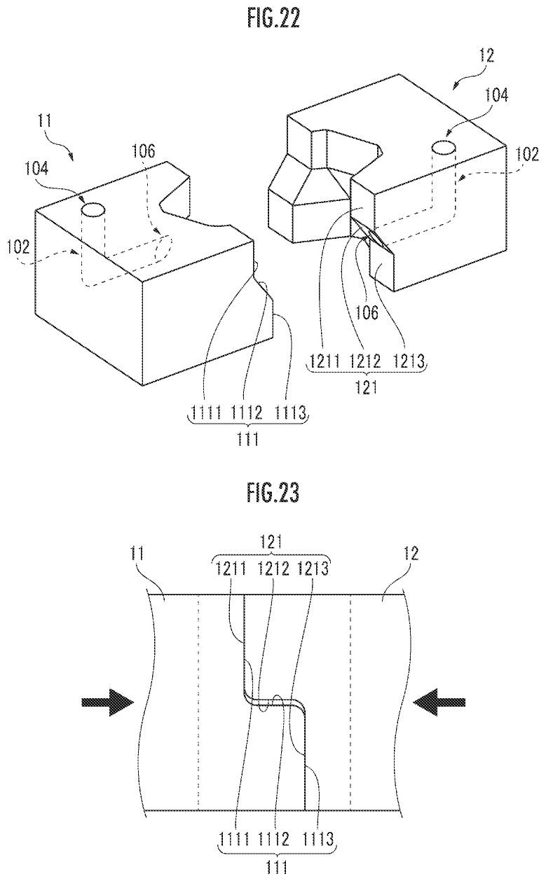

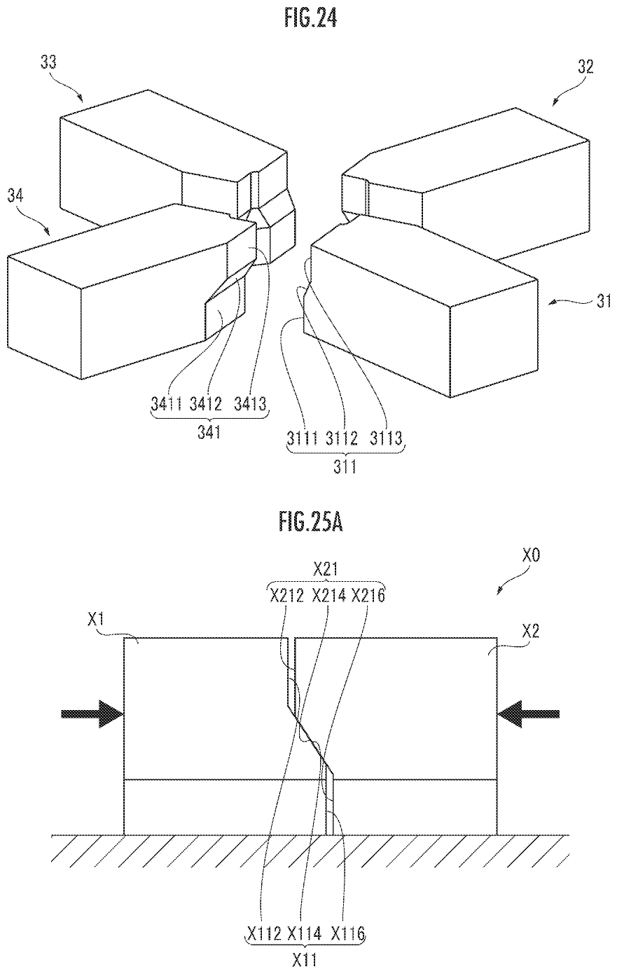

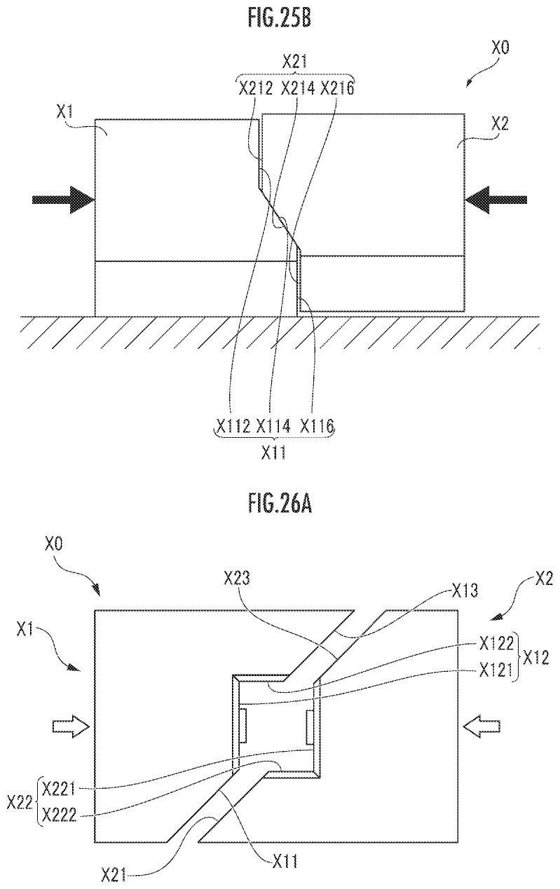

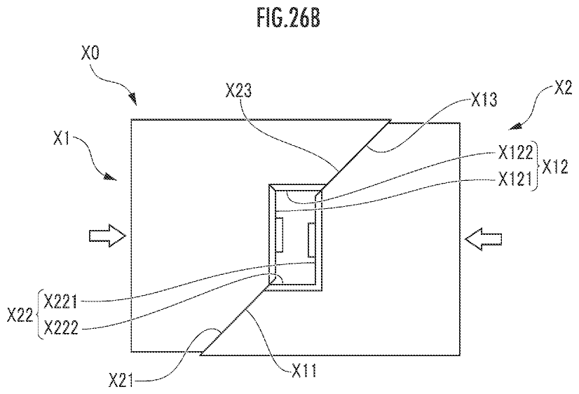

A die 10 as a first embodiment of the present invention, which is shown in FIG. 1, is formed by a first divided die 11 and a second divided die 12. The die 10 is formed by the first divided die 11 and the second divided die 12 which are shaped as if the die 10 is divided in the lateral direction or in the horizontal direction. By the die 10, a powder molded body P2 shaped as shown in FIGS. 21A to 21C is prepared. A side surface 42 of the powder molded body P2 includes an obtuse surface 421 intersecting a reference horizontal plane (a horizontal region of an upper surface 41) at an obtuse angle and an acute surface 422 intersecting the reference horizontal plane at an acute angle. At least a part of a boundary part 44 between at least one surface of the obtuse surface 421 and the acute surface 422 and a surface adjacent to the at least one surface is inclined with respect to the reference horizontal plane.

The first divided die 11 has one pair of divided surfaces 111 and a defining surface 112, The divided surface 111 is constituted by one pair of perpendicular divided surfaces 1111 and 1113 which is offset in each of the translational direction (horizontal direction) of the first divided die 11 and the up-down direction and is perpendicular to the horizontal direction, and an inclined divided surface 1112 (designated divided surface) inclined in the horizontal direction so as to be continuous with each of one perpendicular divided surface 1111 and the other perpendicular divided surface 1113. The defining surface 112 has a shape according to a shape of a part (for example, a right portion) of the side surface 42 of the powder molded body P2 (see FIGS. 21A to 21C). At least one of the one pair of perpendicular divided surfaces 1111 and 1113 forming one divided surface 111, and at least one of the one pair of perpendicular divided surfaces 1111 and 1113 forming the other divided surface 111 form “at least one pair of perpendicular divided surfaces” disposed on the opposite side based on the defining surface 112.

The second divided die 12 has one pair of divided surfaces 121 and a defining surface 122. The divided surface 121 is constituted by one pair of perpendicular divided surfaces 1211 and 1213 which is offset in each of the translational direction (horizontal direction) of the second divided die 12 and the up-down direction and is perpendicular to the horizontal direction, and an inclined divided surface 1212 (designated divided surface) inclined in the horizontal direction so as to be continuous with each of one perpendicular divided surface 1211 and the other perpendicular divided surface 1213. The defining surface 122 has a shape according to a shape of the remaining portion (for example, a left portion) of the side surface 42 of the powder molded body P2 (see FIG. 21A to 21C). At least one of the one pair of perpendicular divided surfaces 1211 and 1213 forming one divided surface 121, and at least one of the one pair of perpendicular divided surfaces 1211 and 1213 forming the other divided surface 121 form “at least one pair of perpendicular divided surfaces” disposed on the opposite side based on the defining surface 122.

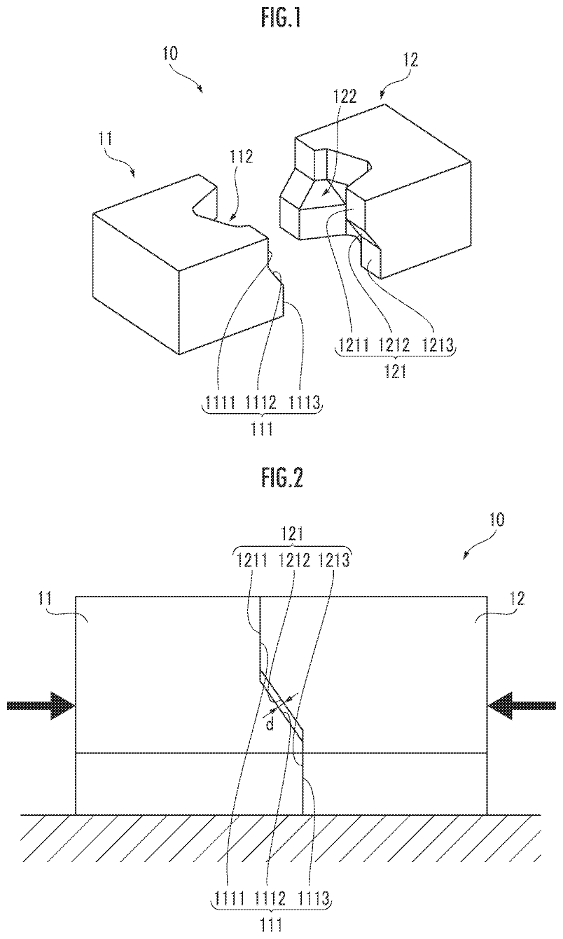

As shown in FIG. 2, the first divided die 11 and the second divided die 12 abut against each other at the perpendicular divided surfaces 1111 and 1113 of the divided surface 111 and the perpendicular divided surfaces 1211 and 1213 of the divided surface 121 respectively. Meanwhile, the inclined divided surfaces 1112 and 1212 are spaced apart from each other with a gap d within a range of 1 to 30 μm, The gap d, along the designated divided surfaces 1112 and 1212, may change by, for example, gradually becoming wider and then gradually becoming narrower or may be constant. The inclined divided surfaces 1112 and 1212 extend along respective two boundary parts 44 of the boundary pails 44 at the side surfaces 42 of the powder molded body P2. In such a state, the first divided die 11 and the second divided die 12 abut against each other, thereby forming a cavity 100 having a shape according to the shape of the side surface 42 of the powder molded body P2.

It is sufficient that each of the first divided die 11 and the second divided die 12. abuts against each other at, at least one of the perpendicular divided surfaces 1111 and 1113 of one divided surface 111 of the first divided die 11 and at least one of the perpendicular divided surfaces 1211 and 1213 of one divided surface 121 of the second divided die 12 and abuts against each other at, at least one of the perpendicular divided surfaces 1111 and 1113 of the other divided surface 111 of the first divided die 11 and at least one of the perpendicular divided surfaces 1211 and 1213 of the other divided surface 121 of the second divided die 12.

For example, the first divided die 11 and the second divided die 12 may abut against each other at the perpendicular divided surface 1111 of one divided surface 111 of the first divided die 11 and the perpendicular divided surface 1211 of one divided surface 121 of the second divided die 12 and may abut against each other at the perpendicular divided surface 1113 of the other divided surface 111 of the first divided die 11 and the perpendicular divided surface 1213 of the other divided surface 121 of the second divided die 12. In this case, the perpendicular divided surface 1113 of one divided surface 111 of the first divided die 11 and the perpendicular divided surface 1213 of one divided surface 121 of the second divided die 12 may be spaced apart from each other with the gap d, and the perpendicular divided surface 1111 of the other divided surface 111 of the first divided die 11 and the perpendicular divided surface 1211 of the other divided surface 121 of the second divided die 12 may be spaced apart from each other with the gap d. Namely, in this case, the perpendicular divided surfaces spaced apart from each other also form the designated divided surfaces.

### Configuration of Die (Second Embodiment)

The die 10 as a second embodiment of the present invention, which is shown in FIG. 3, is formed by the first divided die 11 and the second divided die 12 which are shaped as if the die 10 is divided in the up-down direction. By the die 10, the powder molded body P2 shaped as shown in FIGS. 21A to 21C is prepared, similarly to the die of the first embodiment.

The first divided die 11 has four divided surfaces 111 disposed so as to form four sides of a rectangle, and the defining surface 112. The divided surface 111 is constituted by the one pair of perpendicular divided surfaces 11 and 1113 which is offset in each of the translational direction (vertical direction) of the first divided die 11 and the horizontal direction and is perpendicular to the vertical direction, the inclined divided surface 1112 inclined in the vertical direction so as to be continuous with each of one perpendicular divided surface 1111 and the other perpendicular divided surface 1113, and an inclined divided surface 1114 inclined in the vertical direction so as to be continuous with each of the perpendicular divided surface 1113 and the perpendicular divided surface 1111 of the adjacent divided surface 111. The defining surface 112 has a shape according to a shape of a part (for example, an upper portion) of the side surface 42 of the powder molded body P2 (see FIGS. 21A to 21C). At least one of the one pair of perpendicular divided surfaces 1111 and 1113 forming one divided surface 111, and at least one of the one pair of perpendicular divided surfaces 1111 and 1113 forming the different divided surface 111 not adjacent to the one divided surface 111 form “at least one pair of perpendicular divided surfaces” disposed on the opposite side based on the defining surface 112.

The second divided die 12 has four divided surfaces 121 disposed so as to form four sides of a rectangle, and the defining surface 122. The divided surface 121 is constituted by the one pair of perpendicular divided surfaces 1211 and 1213 which is offset in each of the translational direction (vertical direction) of the second divided die 12 and the horizontal direction and is perpendicular to the vertical direction, the inclined divided surface 1212 inclined in the horizontal direction so as to be continuous with each of one perpendicular divided surface 1211 and the other perpendicular divided surface 1213, and an inclined divided surface 1214 inclined in the vertical direction so as to be continuous with each of the perpendicular divided surface 1213 and the perpendicular divided surface 1211 of the adjacent divided surface 121. The defining surface 122 has a shape according to a shape of the remaining portion (for example, a lower portion) of the side surface 42 of the powder molded body P2 (see FIGS. 21A to 21C). At least one of the one pair of perpendicular divided surfaces 1211 and 1213 forming one divided surface 121, and at least one of the one pair of perpendicular divided surfaces 1211 and 1213 forming the different divided surface 121 not adjacent to the one divided surface 121 form “at least one pair of perpendicular divided surfaces” disposed on the opposite side based on the defining surface 122.

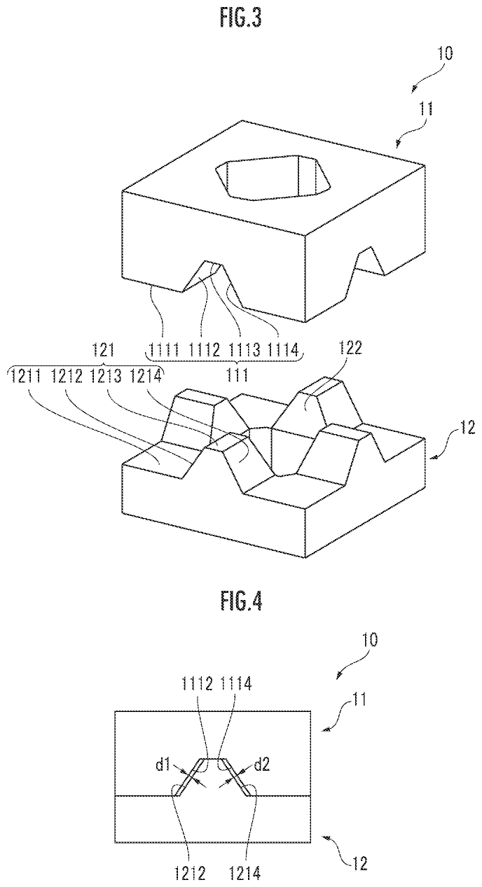

As shown in FIG. 4, the first divided die 11 and the second divided die 12 abut against each other at the one pair of perpendicular divided surfaces 1111 and 1113 of the divided surface 111 and the one pair of perpendicular divided surfaces 1211 and 1213 of the divided surface 121 respectively. Meanwhile, the inclined divided surfaces 1112 and 1212 are spaced apart from each other with a gap dl within a range of 1 to 30 μm, and the inclined divided surfaces 1114 and 1214 are spaced apart from each other with a gap d2 within a range of 1 to 30 μm. The gap d1, along the designated divided surfaces 1112 and 1212, may change by, for example, gradually becoming wider and then gradually becoming narrower or may be constant. Similarly, the gap d2, along the designated divided surfaces 1114 and 1214, may change by, for example, gradually becoming wider and then gradually becoming narrower or may be constant. The inclined divided surfaces 1112, 1114, 1212, and 1214 extend along respective four boundary parts 44 of the boundary parts 44 at the side surfaces 42 of the powder molded body P2. In such a state, the first divided die 11 and the second divided die 12 abut against each other, thereby forming the cavity 100 having a shape according to the shape of the side surface 42 of the powder molded body P2.

It is sufficient that each of the first divided die 11 and the second divided die 12 abuts against each other at, at least one of the perpendicular divided surfaces 1111 and 1113 of one divided surface 111 of the first divided die 11 and at least one of the perpendicular divided surfaces 1211 and 1213 of one divided surface 121 of the second divided die 12 and abuts against each other at, at least one of the perpendicular divided surfaces 1111 and 1113 of the other divided surface 111 disposed on the opposite side based on the defining surface 112 of the first divided die 11 and at least one of the perpendicular divided surfaces 1211 and 1213 of the other divided surface 121 disposed on the opposite side based on the defining surface 122 of the second divided die 12.

For example, the first divided die 11 and the second divided die 12 may abut against each other at the perpendicular divided surface 1111 of one divided surface 111 of the first divided die 11 and the perpendicular divided surface 1211 of one divided surface 121 of the second divided die 12 respectively and may abut against each other at the perpendicular divided surface 1111 of the different divided surface 111 of the first divided die 11 and the perpendicular divided surface 1211 of the different divided surface 121 of the second divided die 12 respectively, In this case, the perpendicular divided surface 1113 of one divided surface 111 of the first divided die 11 and the perpendicular divided surface 1213 of one divided surface 121 of the second divided die 12 may be spaced apart from each other with the gap d, and the perpendicular divided surface 1113 of the different divided surface 111 of the first divided die 11 and the perpendicular divided surface 1213 of the different divided surface 121 of the second divided die 12 may be spaced apart from each other with the gap d. Namely, in this case, the perpendicular divided surfaces spaced apart from each other also form the designated divided surfaces.

### Configuration of Die (Third Embodiment)

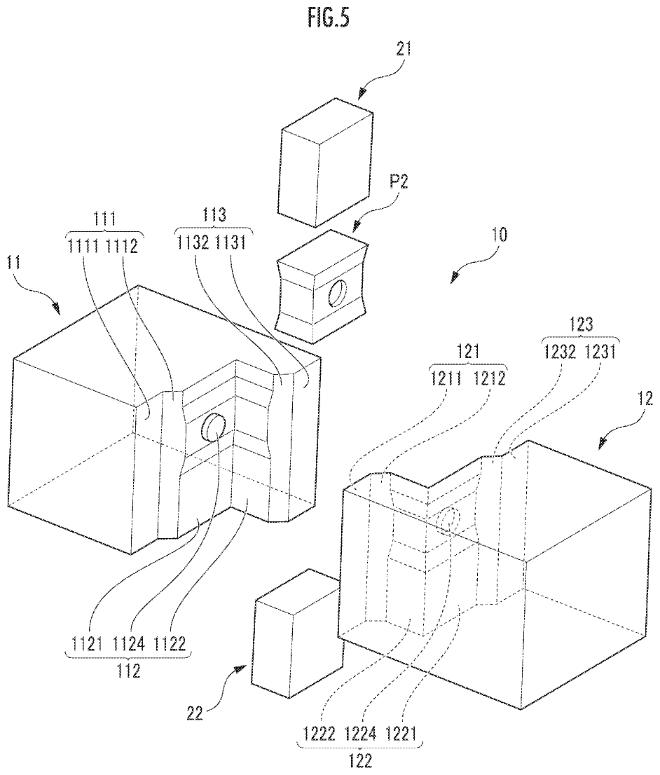

The die 10 as a third embodiment of the present invention, which is shown in FIG. 5, is formed by the first divided die 11 and the second divided die 12.

The first divided die 11 has the first divided surface 111, the defining surface 112, and a second divided surface 113.

The first divided surface 111 is constituted by the perpendicular divided surface 1111 and the inclined divided surface 1112. The perpendicular divided surface 1111 is, at an outer edge, continuous with one side surface of the first divided die 11 and extends in the up-down direction in a posture perpendicular to the translational direction (the front-rear direction in which a direction approaching the second divided die 12 is the front) of the first divided die 11. The inclined divided surface 1112 is, at an outer edge, continuous with an inner edge of the perpendicular divided surface 1111 and extends in the up-down direction in a posture inclined with respect to the translational direction of the first divided die 11.

The defining surface 112 is constituted by a perpendicular defining surface 1121 and a parallel defining surface 1122. The perpendicular defining surface 1121 is, at one side edge, continuous with an inner edge of the inclined divided surface 1112 and extends in the up-down direction in a posture perpendicular to the translational direction of the first divided die 11. The perpendicular defining surface 1121 has a flat portion and a raised portion whose side surface is locally raised in a substantially trapezoidal shape from the flat portion according to a shape of a main surface of the powder molded body P2. The shape of the raised portion may be variously changed, and the raised portion may be omitted. Instead of or in addition to the raised portion, the perpendicular defining surface 1121 may have a depressed portion which is locally depressed or recessed. The shape of the depressed portion may be variously changed. A center portion of the perpendicular defining surface 1121 (or the raised portion) is provided with a projection 1124 projecting in the translational direction of the first divided die 11. The projection 1124 may be omitted. The parallel defining surface 1122 is, at one side edge, continuous with a different side edge of the perpendicular defining surface 1121 and extends in the up-down direction in a posture parallel to the translational direction of the first divided die 11. The parallel defining surface 1122 has a flat portion and a raised portion whose side surface is locally raised in a substantially trapezoidal shape from the flat portion according to the shape of the side surface of the powder molded body P2. The raised portion may be omitted.

The second divided surface 113 is constituted by a perpendicular divided surface 1131 and an inclined divided surface 1132. The perpendicular divided surface 1131 is, at an outer edge, continuous with the other side surface of the first divided die 11 and extends in the up-down direction in a posture perpendicular to the translational direction of the first divided die 11. The inclined divided surface 1132 is, at an outer edge, continuous with an inner edge of the perpendicular divided surface 131 and extends in the up-down direction in a posture inclined with respect to the translational direction of the first divided die 11.

In the first divided die 11, the one pair of perpendicular divided surfaces 1111 and 1131 in which the perpendicular divided surface 1111 forms the first divided surface 111 and the perpendicular divided surface 1131 forms the second divided surface 113 form “at least one pair of perpendicular divided surfaces” disposed on the opposite side based on the defining surface 112.

The second divided die 12 has the first divided surface 121, the defining surface 122, and a second divided surface 123.

The second divided surface 123 is constituted by a perpendicular divided surface 1231 and an inclined divided surface 1232. The perpendicular divided surface 1231 is, at an outer edge, continuous with one side surface of the second divided die 12 and extends in the up-down direction in a posture perpendicular to the translational direction (the front-rear direction in which a direction approaching the first divided die 11 is the front) of the second divided die 12. The inclined divided surface 1232 is, at an outer edge, continuous with an inner edge of the perpendicular divided surface 1231 and extends in the up-down direction in a posture inclined with respect to the translational direction of the second divided die 12.

The defining surface 122 is constituted by a perpendicular defining surface 1221 and a parallel defining surface 1222. The perpendicular defining surface 1221 is, at one side edge, continuous with an inner edge of the inclined divided surface 1232 and extends in the up-down direction in a posture perpendicular to the translational direction of the first divided die 11. The perpendicular defining surface 1221 has a flat portion and a raised portion whose side surface is locally raised in a substantially trapezoidal shape from the flat portion according to the shape of the main surface of the powder molded body P2. The shape of the raised portion may be variously changed, or the raised portion may be omitted. Instead of or in addition to the raised portion, the perpendicular defining surface 1221 may have a depressed portion which is locally depressed or recessed. The shape of the depressed portion may be variously changed. A center portion of the perpendicular defining surface 1221 (or the raised portion) is provided with a projection 1224 projecting in the translational direction of the first divided die 11. The projection 1224 may be omitted. The parallel defining surface 1222 is, at one side edge, continuous with a different side edge of the perpendicular defining surface 1221 and extends in the up-down direction in a posture parallel to the translational direction of the first divided die 11. The parallel defining surface 1222 has a flat portion and a raised portion whose side surface is locally raised in a substantially trapezoidal shape from the flat portion according to the shape of the side surface of the powder molded body P2. The raised portion may be omitted.

The first divided surface 121 is constituted by the perpendicular divided surface 1211 and the inclined divided surface 1212. The perpendicular divided surface 1211 is, at an outer edge, continuous with the other side surface of the second divided die 12 and extends in the up-down direction in a posture perpendicular to the translational direction of the second divided die 12. The inclined divided surface 1212 is, at an outer edge, continuous with an inner edge of the perpendicular divided surface 1211 and extends in the up-down direction in a posture inclined with respect to the translational direction of the second divided die 12.

In the second divided die 12, the one pair of perpendicular divided surfaces 1211 and 1231 in which the perpendicular divided surface 1211 forms the first divided surface 121 and the perpendicular divided surface 1231 forms the second divided surface 123 form “at least one pair of perpendicular divided surfaces” disposed on the opposite side based on the defining surface 122.

As shown in FIG. 6, the first divided die 11 and the second divided die 12 abut against each other at the perpendicular divided surfaces 1111 and 1131 of the divided surface 111 and the perpendicular divided surfaces 1211 and 1231 of the divided surface 121. Meanwhile, the first divided die 11 and the second divided die 12 are spaced apart from each other with the gap d within the range of 1 to 30 μm at the inclined divided surfaces 1112 and 1132 and 1212 and 1232. In such a state, the first divided die 11 and the second divided die 12 abut against each other, thereby forming the cavity 100 having a shape according to the shapes of the main surface of the powder molded body P2 and a part of the side surface (or the entire side surface) of the powder molded body P2.

A ridge or edge portion of the powder molded body P2 is formed by each of inner edges of the respective inclined divided surfaces 1112 and 1212 abutting against each other and inner edges of the respective inclined divided surfaces 1132 and 1232 abutting against each other.

Thus, while a plurality of the divided dies 11 and 12 abuts against each other at the inclined divided surfaces 1112 and 1212 forming the divided surfaces 111 and 121 thereof, a situation is reliably avoided in which the divided dies 11 and 12 are driven so as to be displaced in a direction different from the translational direction. Furthermore, the gap d between the inclined divided surfaces 1112 and 1212 and the gap d between the inclined divided surfaces 1132 and 1232 are within the range of 1 to 30 μm, and a situation is suppressed in which a raw material powder having an average particle size equal to or larger than the gap protrudes from the cavity 100 into the gap d. Thereby, relative displacement of the plurality of divided dies 11 and 12 in a direction different from the translational direction, which is derived from appearance of the situation, is reliably prevented from occurring, and molding accuracy of the cavity 100 and consequently shape accuracy of the powder molded body P2 are improved.

### Configuration of Die (Fourth Embodiment)

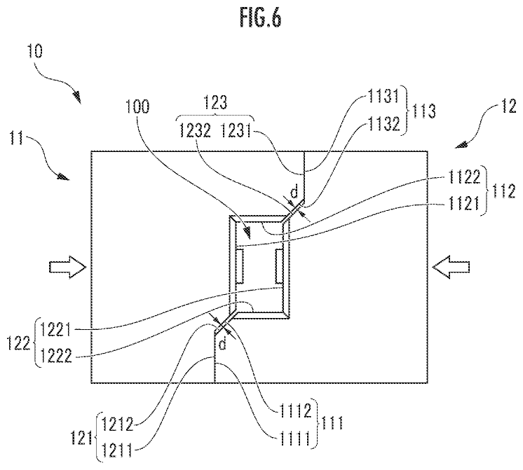

The die 10 as a fourth embodiment of the present invention, which is shown in FIG. 7, is different from the die 10 of the third embodiment (see FIGS. 5 and 6) in configurations of the first divided surface 111 and second divided surface 113 of the first divided die 11 and the first divided surface 121 and second divided surface 123 of the second divided die 12. The other configurations of the die 10 of the fourth embodiment are substantially the same as those of the die 10 of the third embodiment, and thus the same configurations are marked with the same reference signs as those of the third embodiment and description thereof is omitted.

As shown in FIG. 7, the first divided surface 111 is constituted by the perpendicular divided surface 1111, an inclined divided surface 11121, and a parallel divided surface 11122. The perpendicular divided surface 1111 is, at an outer edge, continuous with one side surface of the first divided die 11 and extends in the up-down direction at a lower portion of the first divided die 11 in a posture perpendicular to the translational direction (the front-rear direction in which a direction approaching the second divided die 12 is the front) of the first divided die 11. The inclined divided surface 11121 is continuous with one side surface of the first divided die 11 and extends in the up-down direction in a posture inclined with respect to the translational direction of the first divided die 11 at an upper portion of the first divided die 11. The parallel divided surface 11122 is, at a rear end edge, continuous with a lower edge of the inclined divided surface 11121, at a front end edge, continuous with an upper edge of the perpendicular divided surface 1111, and extends in the horizontal direction in a posture parallel to the translational direction of the first divided die 11.

As shown in FIG. 7, the second divided surface 113 is constituted by the perpendicular divided surface 1131, an inclined divided surface 11321, and a parallel divided surface 11322. The perpendicular divided surface 1131 is, at an outer edge, continuous with one side surface of the first divided die 11 and extends in the up-down direction at the lower portion of the first divided die 11 in a posture perpendicular to the translational direction of the first divided die 11. The inclined divided surface 11321 is continuous with one side surface of the first divided die 11 and extends in the up-down direction in a posture inclined with respect to the translational direction of the first divided die 11 at the upper portion of the first divided die 11. In the present embodiment, the inclined divided surface 11321 is parallel to the inclined divided surface 11121. The parallel divided surface 11322 is, at a rear end edge, continuous with a lower edge of the inclined divided surface 11321, at a front end edge, continuous with an upper edge of the perpendicular divided surface 1131, and extends in the horizontal direction in a posture parallel to the translational direction of the first divided die 11.

As shown in FIG. 7, the first divided surface 121 is constituted by the perpendicular divided surface 1211, an inclined divided surface 12121, and a parallel divided surface 12122. The perpendicular divided surface 1211 is, at an outer edge, continuous with one side surface of the second divided die 12 and extends in the up-down direction at a lower portion of the first divided die 11 in a posture perpendicular to the translational direction (the front-rear direction in which a direction approaching the second divided die 12 is the front) of the second divided die 12. The inclined divided surface 12121 is continuous with one side surface of the second divided die 12 and extends in the up-down direction in a posture inclined with respect to the translational direction of the second divided die 12 at an upper portion of the second divided die 12. The parallel divided surface 12122 is, at a rear end edge, continuous with a lower edge of the inclined divided surface 12121, at a front end edge, continuous with an upper edge of the perpendicular divided surface 1211, and extends in the horizontal direction in a posture parallel to the translational direction of the second divided die 12.

As shown in FIG. 7, the second divided surface 123 is constituted by the perpendicular divided surface 1231, an inclined divided surface 12321, and a parallel divided surface 12322. The perpendicular divided surface 1231 is, at an outer edge, continuous with one side surface of the second divided die 12 and extends in the up-down direction at the lower portion of the second divided die 12 in a posture perpendicular to the translational direction of the second divided die 12. The inclined divided surface 12321 is continuous with one side surface of the second divided die 12 and extends in the up-down direction in a posture inclined with respect to the translational direction of the second divided die 12 at the upper portion of the second divided die 12. In the present embodiment, the inclined divided surface 12321 is parallel to the inclined divided surface 12121. The parallel divided surface 12322 is, at a rear end edge, continuous with a lower edge of the inclined divided surface 12321, at a front end edge, continuous with an upper edge of the perpendicular divided surface 1231, and extends in the horizontal direction in a posture parallel to the translational direction of the second divided die 12.

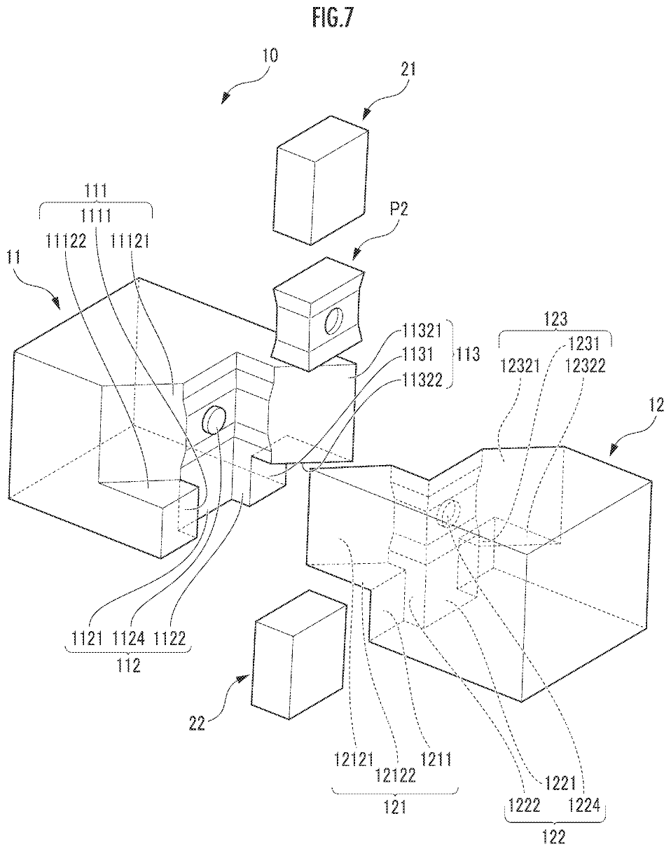

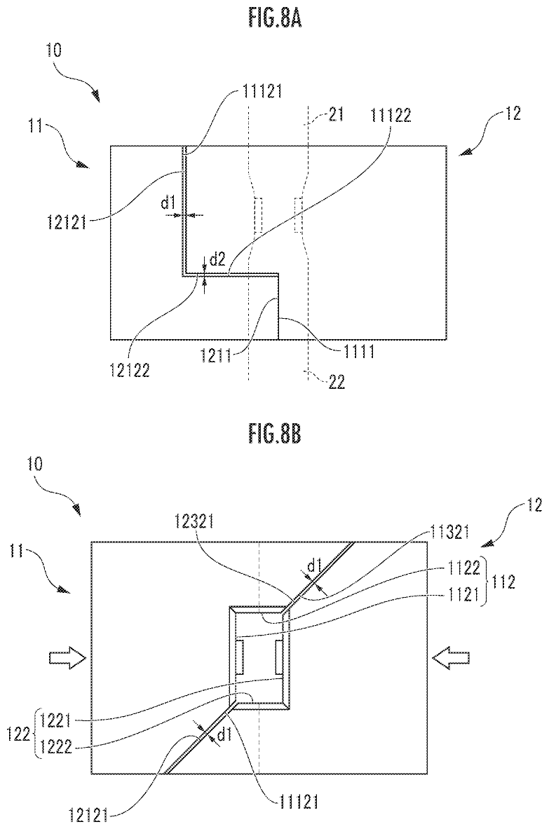

As shown in FIG. 8A, the first divided die 11 and the second divided die 12 abut against each other at the perpendicular divided surfaces 1111 and 1131 of the divided surface 111 and the perpendicular divided surfaces 1211 and 1231 of the divided surface 121. Meanwhile, as shown in FIGS. 8A and 8B, the first divided die 11 and the second divided die 12 are spaced apart from each other with the gap di within the range of 1 to 30 μm at the inclined divided surfaces 11121 and 11321 and 12121 and 12321. Furthermore, as shown in FIG. 8A, the first divided die 11 and the second divided die 12 are spaced apart from each other with the gap d2 within the range of 1 to 30 μm at the parallel divided surfaces 11122 and 11322 and 12122 and 12322. In such a state, the first divided die 11 and the second divided die 12 abut against each other, thereby forming the cavity 100 having a shape according to the shape of the side surface of the powder molded body P2.

### Configuration of Die (Fifth Embodiment)

As in the die 10 as a fifth embodiment of the present invention, which is shown in FIG. 9, the shapes of the cavity 100 and the defining surface which defines this may differ from those of the fourth embodiment of the present invention.

### Configuration of Die (Sixth Embodiment)

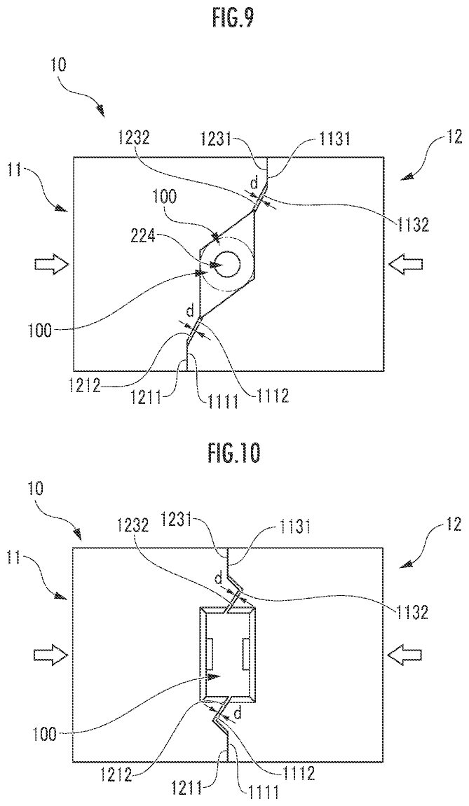

As in the die 10 as a sixth embodiment of the present invention, which is shown in FIG. 10, the inclined divided surfaces 1112, 1132, 1212, and 1232 each may be constituted by a substantially bent surface as if being bent along a line segment extending in the up-down direction.

### Configuration of Die (Seventh Embodiment)

As in the die 10 as a seventh embodiment of the present invention, which is shown in FIG. 11, the inclined divided surfaces 1112, 1132, 1212, and 1232 each may be constituted by a substantially bent surface as if being bent along a line segment extending in the up-down direction, and one plane bent with respect to the other plane may extend substantially parallel to the translational direction of the divided dies 11 and 12.

### Configuration of Die (Eighth Embodiment)

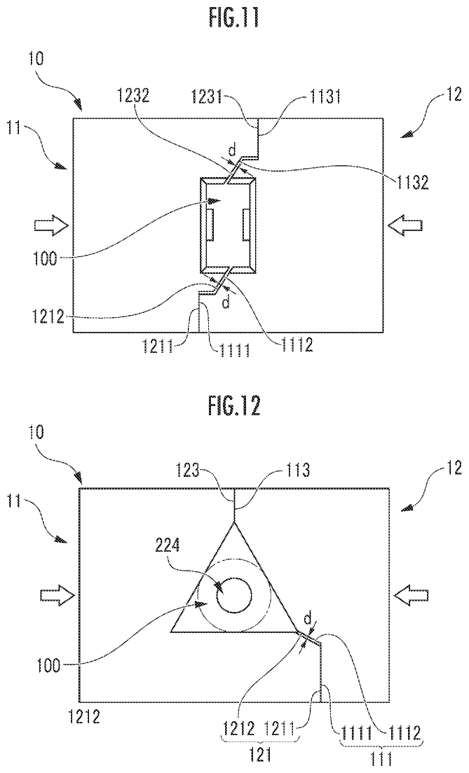

As in the die 10 as an eighth embodiment of the present invention, which is shown in FIG. 12, while the first divided surfaces 111 and 121 are constituted by the perpendicular divided surfaces 1111 and 1211 and the inclined divided surfaces 1112 and 1212, the second divided surfaces 113 and 123 each may be constituted by only a perpendicular divided surface.

### Configuration of Die (Ninth Embodiment)

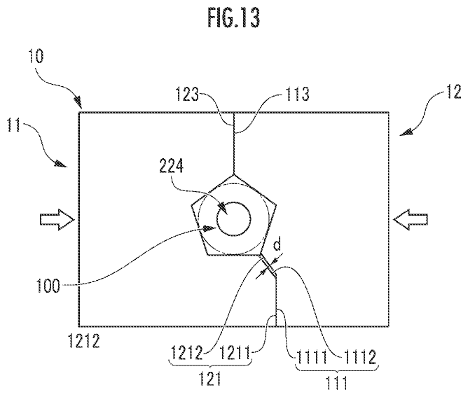

As in the die 10 as a ninth embodiment of the present invention, which is shown in FIG. 13, similarly to the eighth embodiment, while the first divided surfaces 111 and 121 are constituted by the perpendicular divided surfaces 1111 and 1211 and the inclined divided surfaces 1112 and 1212, the second divided surfaces 113 and 123 each may be constituted by only a perpendicular divided surface.

### Configuration of Powder Molding Apparatus (First Embodiment)

A powder molding (or compacting) apparatus as the first embodiment of the present invention, which is shown in FIG. 14, comprises the die 10 as the first embodiment of the present invention, which is shown in FIGS. 1 and 2. The powder molding apparatus further comprises a first die drive mechanism 110 and a second die drive mechanism 120 for translating the first divided die 11 and the second divided die respectively in the horizontal direction, an upper punch 21 and a lower punch 22 which are inserted from the upper direction and the lower direction respectively into a cavity formed by abutment of the first divided die 11 and the second divided die 12, and a first lifting and lowering drive mechanism 210 and a second lifting and lowering drive mechanism 220 for lifting and lowering the upper punch 21 and the lower punch 22 respectively.

The upper punch 21 is open at a tip portion thereof (lower end portion) and has a receiving space 212 formed thereon which extends upward from the opening along a center axis thereof. The lower punch 22 is open at a tip portion thereof (upper end portion) and has a through hole formed thereon which extends downward from the opening along a center axis thereof, and a rod 224 is inserted into the through hole in a relatively movable form in the axis direction with respect to the lower punch 22. A lifting and lowering drive mechanism which lifts and lowers the rod 224 may be provided (illustration omitted).

### Configuration of Powder Molding Apparatus (Second Embodiment)

A powder molding apparatus as the second embodiment of the present invention, which is shown in FIG. 15, comprises the die 10 as the second embodiment of the present invention, which is shown in FIGS. 3 and 4, and the die drive mechanism 110 for translating the first divided die 11 in the vertical direction. The other configurations are substantially the same as those of the powder molding apparatus of the first embodiment and thus are denoted by the same reference signs, and description thereof is omitted.

### Configuration of Powder Molding Apparatus (Third Embodiment)

A powder molding apparatus as the third embodiment of the present invention, which is shown in FIG. 16, comprises the die 10 as the third embodiment of the present invention, which is shown in FIGS. 5 and 6. The powder molding apparatus further comprises the first die drive mechanism 110 and the second die drive mechanism 120 for translating the first divided die 11 and the second divided die 12 respectively in the horizontal direction, the upper punch 21 and the lower punch 22 which are inserted from the upper direction and the lower direction respectively into a cavity formed by abutment. of the first divided die 11 and the second divided die 12, and the first lifting and lowering drive mechanism 210 and the second lifting and lowering drive mechanism 220 for lifting and lowering the upper punch 21 and the lower punch 22 respectively.

### Method for Preparing Powder Molded Body (First Embodiment)

A method for preparing (or manufacturing) the powder molded body P2 as the first embodiment of the present. invention (see FIGS. 21A to 21C) uses the powder molding apparatus as the first embodiment of the present invention (see FIGS. 14, 1, and 2).

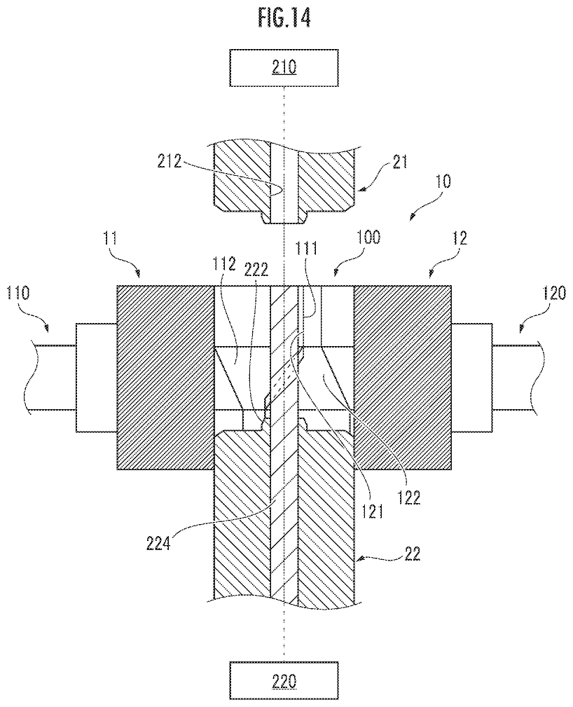

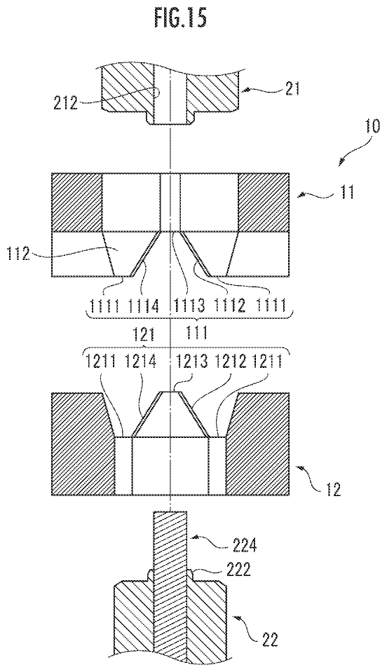

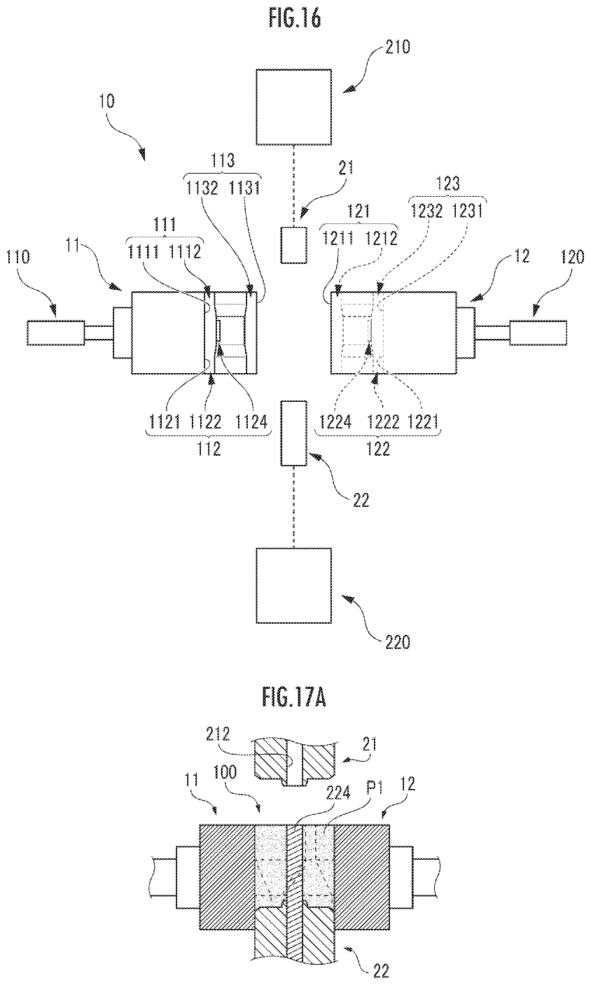

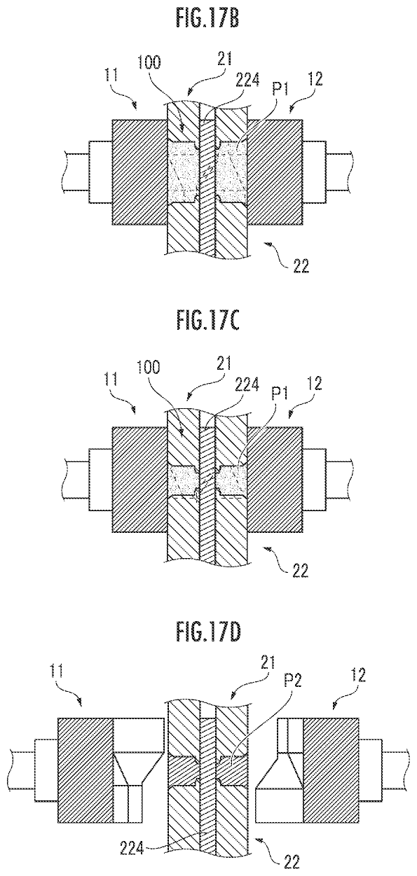

First, as shown in FIG. 17A, the first divided die 11 and the second divided die 12 are translationally driven by the first die drive mechanism 110 and the second die drive mechanism 120 respectively so as to approach each other. Then, the first divided die 11 and the second divided die 12 abut against each other, and a side of the cavity 100 is defined by the defining surfaces 112 and 122. The lower punch 22 is driven upward by the second lifting and lowering drive mechanism 220 and inserted into the cavity 100. At this time, the rod 224 projects upward from the tip portion of the lower punch 22. Timings at which the side of the cavity 100 and the lower punch are inserted may be reversed in order in time series or may be simultaneous.

As shown in FIG. 17A, in this state, a raw material powder P1 is put into the cavity 100 by, for example, a powder supply apparatus (illustration omitted) and filled in the cavity 100 so as to surround the rod 224.

Subsequently, as shown in FIG. 17B, the upper punch 21 is driven downward by the first lifting and lowering drive mechanism 210 and inserted into the cavity 100, moving to a predetermined position before pressurization. At this time, the rod 224 is inserted into a receiving space 212 of the upper punch 21.

Thereafter, as shown in FIG. 17C, so that the upper punch 21 and the lower punch 22 relatively approach each other further, at least one of the upper punch 21 and the lower punch 22 is driven, thereby pressure molding the raw material powder P1.

Next, as shown in FIG. 17D, each of the first divided die 11 and the second divided die 12 is translationally driven so as to be spaced apart from each other. Before the first divided die 11 and the second divided die 12 are spaced apart from each other, the upper punch 21 may be driven upward first.

Then, as shown in FIG. 17E, the upper punch 21 and the lower punch 22 are both driven upward, and the rod 224 is driven downward relative to the lower punch 22, thereby removing the powder molded body P2 from the cavity 100. Alternatively, from a state shown in FIG. 17D, a plate to which the first divided die 11 and the second divided die 12 are attached may be provided with a drive mechanism in the up-down direction, and thereby the first divided die 11 and the second divided die 12 may be driven downward. Then, the powder molded body P2 is heat treated at a sintering furnace, thereby preparing a sintered body.

### Method for Preparing Powder Molded Body (Second Embodiment)

A method for preparing a powder molded body as the second embodiment of the present invention uses the powder molding apparatus as the second embodiment of the present invention (see FIGS. 15, 3, and 4).

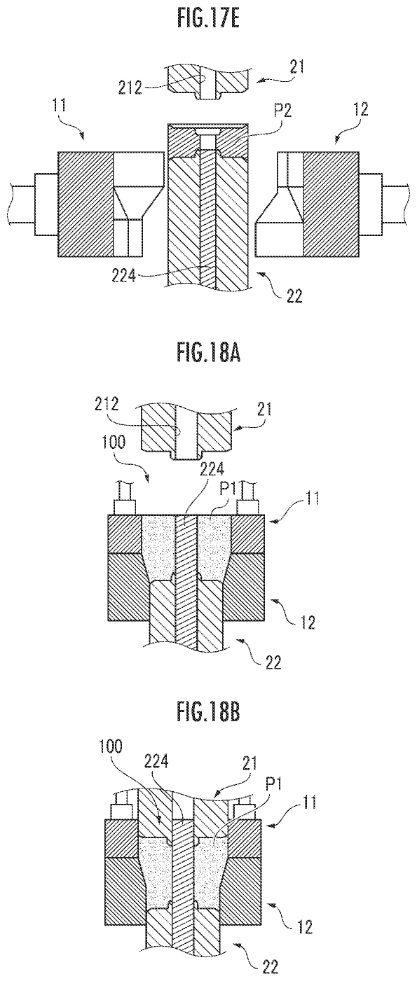

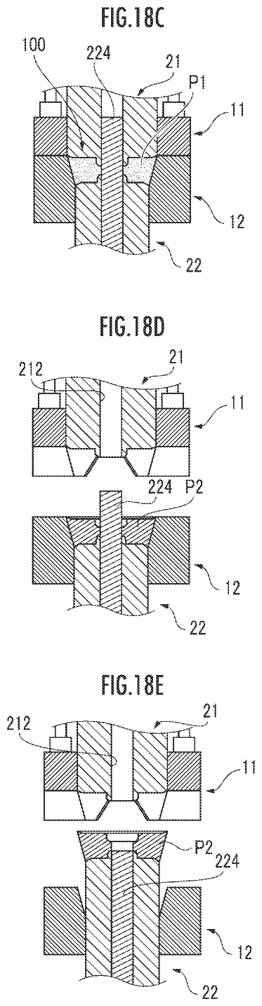

First, the first divided die 11 is driven downward by the die drive mechanism 110 so as to mutually approach the second divided die 12. As a result, as shown in FIG. 18A, each of the first divided die 11 and the second divided die 12 abuts against each other, and the side of the cavity 100 is defined by the defining surfaces 112 and 122. The lower punch 22 is driven upward by the second lifting and lowering drive mechanism 220 and inserted into the cavity 100. At this time, the rod 224 projects upward from the tip portion of the lower punch 22. Timings at which the side of the cavity 100 and the lower punch 22 are inserted may be reversed in order in time series or may be simultaneous.

As shown in FIG. 18A, in this state, the raw material powder P1 is put into the cavity 100 by, for example, a powder supply apparatus (illustration omitted) and filled in the cavity 100 so as to surround the rod 224.

Subsequently, as shown in FIG. 18B, the upper punch 21 is driven downward by the first lifting and lowering drive mechanism 210 and inserted into the cavity 100, moving to a predetermined position before pressurization. At this time, the rod 224 is inserted into the receiving space 212 of the upper punch 21.

Thereafter, as shown in FIG. 18C, so that the upper punch 21 and the lower punch 22 relatively approach each other further, at least one of the upper punch 21 and the lower punch 22 is driven, thereby pressure molding the raw material powder P1.

Next, as shown in FIG. 18D, so that each of the first divided die 11 and the second divided die 12 is spaced apart from each other, the first divided die 11 is driven upward. Before the first divided die 11 and the second divided die 12 are spaced apart from each other, the upper punch 21 may be driven upward first.

Then, as shown in FIG. 18E, the upper punch 21 and the lower punch 22 are both driven upward, and the rod 224 is driven downward relative to the lower punch 22, thereby removing the powder molded body P2 from the cavity 100. Alternatively, from a state shown in FIG. 18D, a plate to which the second divided die 12 is attached may be provided with a drive mechanism in the up-down direction, and thereby the second divided die 12 may be driven downward. Then, the powder molded body P2 is heat treated at a sintering furnace, thereby preparing a sintered body.

### Method for Preparing Sintered Body (Third Embodiment)

A method for preparing a powder molded body as the third embodiment of the present invention uses the powder molding apparatus as the third embodiment of the present invention (see FIGS. 16, 5, and 6).

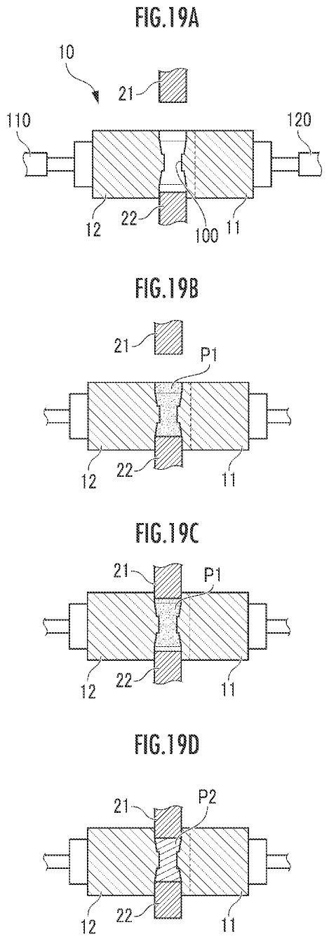

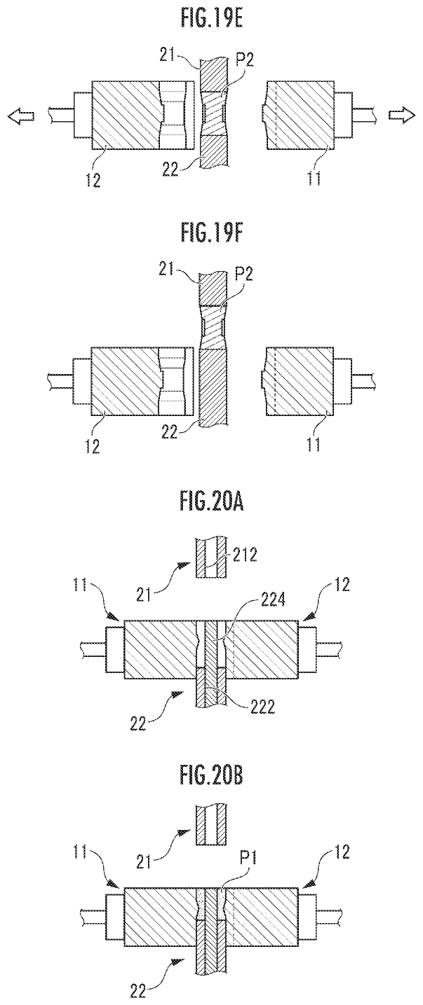

First, the first divided die 11 and the second divided die 12 are translationally driven by the first die drive mechanism 110 and the second die drive mechanism 120 respectively so as to approach each other. As a result, as shown in FIG. 19A, the first divided die 11 and the second divided die 12 abut against each other, and the side of the cavity 100 is defined by the defining surfaces 112 and 122. Similarly, as shown in FIG. 19A, the lower punch 22 is driven upward by the second lifting and lowering drive mechanism 220 and inserted into the cavity 100. Timings at which the side of the cavity 100 and the lower punch 22 are inserted may be reversed in order in time series or may be simultaneous.

As shown in FIG. 19B, in this state, the raw material powder P1 is put into the cavity 100 by, for example, a powder supply apparatus (illustration omitted). Subsequently, as shown in FIG. 19C, the upper punch 21 is driven downward by the first lifting and lowering drive mechanism 210 and inserted into the cavity 100, moving to a predetermined position before pressurization. Thereafter, as shown in FIG. 19D, so that the upper punch 21 and the lower punch 22 relatively approach each other further, at least one of the upper punch 21 and the lower punch 22 is driven, thereby pressure molding the raw material powder P1. Next, as shown in FIG. 19E, each of the first divided die 11 and the second divided die 12 is translationally driven so as to be spaced apart from each other. Before the first divided die 11 and the second divided die 12 are spaced apart from each other, the upper punch 21 may be driven upward first. Thereafter, as shown in FIG. 19F, the upper punch 21 and the lower punch 22 are both driven upward, thereby removing the powder molded body P2 from the cavity 100. Alternatively, from a state shown in FIG. 19E, a plate to which the first divided die 11 and the second divided die 12 are attached may be provided with a drive mechanism in the up-down direction, and thereby the first divided die 11 and the second divided die 12 may be driven downward. Then, the powder molded body P2 is heat treated at a sintering furnace, thereby preparing a sintered body.

### Method for Preparing Sintered Body (Fifth Embodiment)

A method for preparing a powder molded body as the fifth embodiment of the present invention uses the powder molding apparatus as the third embodiment of the present invention which uses the die 10 as the fifth embodiment of the present invention (see FIGS. 14, 16 and 9).

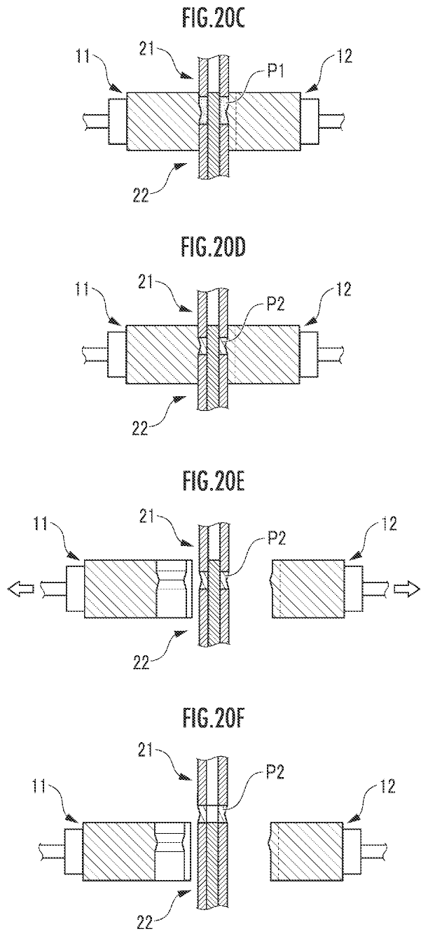

First, the first divided die 11 and the second divided die 12 are translationally driven by the first die drive mechanism 110 and the second die drive mechanism 120 respectively so as to approach each other. As a result, as shown in FIG. 20A, the first divided die 11 and the second divided die 12 abut against each other, and the side of the cavity 100 is defined by the defining surfaces 112 and 122, Similarly, as shown in FIG. 20A, the lower punch 22 is driven upward by the second lifting and lowering drive mechanism 220 and inserted into the cavity 100. At this time, the rod 224 inserted into a through hole 222 of the lower punch 22 projects upward from the tip portion of the lower punch 22. Timings at which the side of the cavity 100 and the lower punch 22 are inserted may be reversed in order in time series or may be simultaneous.

As shown in FIG. 20B, in this state, the raw material powder P1 is put into the cavity 100 by, for example, a powder supply apparatus (illustration omitted) and filled in the cavity 100 so as to surround the rod 224.

Subsequently, as shown in FIG. 20C, the upper punch 21 is driven downward by the first lifting and lowering drive mechanism 210 and inserted into the cavity 100, moving to a predetermined position before pressurization. At this time, the rod 224 is inserted into the receiving space 212 of the upper punch 21.

Thereafter, as shown in FIG. 20D, so that the upper punch 21 and the lower punch 22 relatively approach each other further, at least one of the upper punch 21 and the lower punch 22 is driven, thereby pressure molding the raw material powder P1.

Next, as shown in FIG. 20E, each of the first divided die 11 and the second divided die 12 is translationally driven so as to be spaced apart from each other. Before the first divided die 11 and the second divided die 12 are spaced apart from each other, the upper punch 21 may be driven upward first.

Then, as shown in FIG. 20F, the upper punch 21 and the lower punch 22 are both driven upward, and the rod 224 is driven downward relative to the lower punch 22, thereby removing the powder molded body P2 from the cavity 100. Alternatively, from a state shown in FIG. 20E, a plate to which the first divided die 11 and the second divided die 12 are attached may be provided with a drive mechanism in the up-down direction, and thereby the first divided die 11 and the second divided die 12 may be driven downward. Then, the powder molded body P2 is heat treated at a sintering furnace, thereby preparing a sintered body.

### Other Embodiments of the Present Invention

The powder molding apparatus may further comprise a gas supply device (illustration omitted), and at least one divided die of the plurality of divided dies 11 and 12 may have a ventilation passage for supplying gas supplied from the gas supply device, to the outside of the at least one divided die through an opening of the divided surface.

For example, according to the die 10 as a modified embodiment of the first embodiment of the present invention, which is shown in FIG. 22, a ventilation passage 102 is provided which extends inside each of the first divided die 11 and the second divided die 12 from one opening 104 to the other opening 106. The one opening 104 is provided at a portion (for example, an upper surface) except for the divided surfaces 111 and 121 and defining surfaces 112 and 122 of the respective divided dies 11 and 12 and is connected to a ventilation passage of the gas supply device. The other opening 106 is provided at one divided surface 111 of the divided die 11 and one divided surface 121 of the divided die 12, more specifically, at the inclined divided surfaces 1112 and 1212.

According to the powder molding apparatus with the configuration, in a state where the plurality of divided dies 11 and 12 is spaced apart from each other at the perpendicular divided surfaces 1111 and 1113 forming the divided surface 111 and the perpendicular divided surfaces 1211 and 1213 forming the divided surface 121 respectively (see FIG. 2), the gas can be supplied through the ventilation passage 102 to a gap between the divided surfaces 111 and 121. Thus, a raw material powder or dust or the like which is present in gaps between the perpendicular divided surfaces 1111 and 1211 and between the perpendicular divided surfaces 1113 and 1213 which form the divided surfaces 111 and 121 is removed by the gas flow, and the perpendicular divided surfaces 1111 and 1113 can reliably abut against the perpendicular divided surfaces 1211 and 1213 respectively with no raw material powder being caught. Thereby, the molding accuracy of the cavity 100 and consequently the shape accuracy of the powder molded body P2 are further improved. Furthermore, the gas can be supplied through the ventilation passage 102 to a gap between the inclined divided surfaces 1112 and 1212 forming the divided surfaces 111 and 121 of the plurality of respective divided dies 11 and 12. Thus, a raw material powder present in the gap between the inclined divided surfaces 1112 and 1212. forming the divided surfaces 111 and 121 is removed by the gas flow. Thereby, while a workload for removing, from the powder molded body P2 or the sintered body, a burr derived from the raw material powder present in the gap between the inclined divided surfaces 1112 and 1212 is reduced, the shape accuracy of the powder molded body P2. (consequently, the sintered body) is further improved.

In a state where the plurality of divided dies 11 and 12 abuts against each other at the perpendicular divided surfaces 1111 and 1113 forming the divided surface 111 and the perpendicular divided surfaces 1211 and 1213 forming the divided surface 121 respectively, the gas can be supplied to the gap (see FIGS. 2 and 4) between the inclined divided surfaces 1112 and 1212 forming the divided surfaces 111 and 121. Thus, after the plurality of divided dies 11 and 12 abuts against each other and thereby the cavity 100 is formed, a raw material powder protruding from the cavity 100 to the gap is removed by the gas flow. Thereby, while a workload for removing, from the powder molded body P1 or the powder molded body P2, a burr derived from the protruding raw material powder is reduced, the shape accuracy of the powder molded body P1 and consequently powder molded body P2 is further improved.

In the modified embodiment, the ventilation passage 102 may be formed so that, in addition to or instead of the inclined divided surfaces 1112 and 1212, the perpendicular divided surfaces 1111, 1113, 1211, and 1213 have the other opening 106. Design items such as the extension form (shape) of the ventilation passage 102 and the number, shape, and size of the ventilation passages 104 and 106 may be arbitrarily changed.

Although in the embodiment, the designated divided surface is constituted by the inclined divided surface inclined with respect to the horizontal direction, as another embodiment, the designated divided surface may be constituted by, instead of or in addition to the inclined divided surface, a parallel divided surface parallel to the horizontal direction. For example, as shown in FIG. 23, the designated divided surfaces 1112 and 1212 at the divided surfaces 111 and 121 of the divided dies 11 and 12 each may be constituted by a curved surface or a convex curved surface (an inclined divided surface whose inclination angle with respect to the horizontal direction is not constant) which is continuous with the parallel divided surface and both edges thereof.

Although in the embodiment, the designated divided surface is constituted by the inclined divided surface inclined with respect to the horizontal direction at a constant angle, as another embodiment, the designated divided surface may be constituted by an inclined divided surface whose inclination angle with respect to the horizontal direction is not constant as in a curved surface, a bent surface, a convex curved surface, or a concave curved surface.

Although in the embodiment, the die is divided into two divided dies, as another embodiment, the die may be divided into a plurality of three or more divided dies. For example, as shown in FIG. 24, the die 10 may be constituted by four divided dies 31 to 34. In each of the divided dies 31 to 34, each of components marked with a reference sign “3X . . . ” (X=1, 2, 3, 4) corresponds to each of components of the divided dies 11 and 12 which are marked with a reference sign “1Y . . . ” (Y=1, 2) in the embodiment, and thus further description thereof is omitted.

### Reference Signs List

10: die, 11: first divided die, 12: second divided die, 21: upper punch, 22: lower punch, 31: divided die, 32: divided die, 33: divided die, 34: divided die, 41: upper surface, 42: side surface, 43: lower surface, 44: boundary part, 100: cavity, 102: ventilation passage, 104: opening, 106: opening, 110: first die drive mechanism, 120: second die drive mechanism. 111, 121: divided surface (first divided surface), 112, 122: defining surface, 113, 123: second divided surface, 210: first lifting and lowering drive mechanism, 212: receiving space of upper punch for rod 224, 220: second lifting and lowering drive mechanism, 222: through hole of lower punch, 224: rod, 421: obtuse surface, 422: acute surface, 1111: perpendicular divided surface, 1112: designated divided surface (inclined divided surface, parallel divided surface), 1113: perpendicular divided surface, 1114: designated divided surface (inclined divided surface), 1131: perpendicular divided surface, 1132: inclined divided surface, 1211: perpendicular divided surface, 1212: designated divided surface (inclined divided surface, parallel divided surface), 1213: perpendicular divided surface, 1214: designated divided surface (inclined divided surface), 1231: perpendicular divided surface, 1232: inclined divided surface, P1: raw material powder, P2: powder molded body.

1. A powder molding apparatus comprising:
a plurality of divided dies configured to abut against each other, thereby forming a cavity according to a shape of a side surface of a powder molded body;
a die drive mechanism configured to relatively translate the plurality of divided dies;
an upper punch and a lower punch configured to be inserted from an upper direction and a lower direction respectively into the cavity formed by the plurality of divided dies; and
a lifting and lowering drive mechanism configured to lift and lower each of the upper punch and the lower punch,
each of the plurality of divided dies comprising:
a defining surface configured to define the cavity; and
a divided surface, the divided surface comprising:
a designated divided surface constituted by at least one of an inclined divided surface inclined with respect to a translational direction of each of the plurality of divided dies and a parallel divided surface parallel to the translational direction; and.
at least one pair of perpendicular divided surfaces disposed on an opposite side based on the defining surface, the at least one pair of perpendicular divided surfaces being perpendicular to the translational direction,
wherein each of the plurality of divided dies, while abutting against each other at the at least one pair of perpendicular divided surfaces of the divided surface, abuts against each other in a state of being spaced apart from each other with a gap within a range of 1 to 30 μm at the designated divided surface, thereby forming the cavity.

2. The powder molding apparatus according to claim 1,
wherein the powder molding apparatus further comprises a gas supply device, and
at east one divided die of the plurality of divided dies comprises a ventilation passage configured to supply gas supplied from the gas supply device, to an outside of the at least one divided die through an opening of the divided surface.

3. The powder molding apparatus according to claim 2,
wherein the opening of the ventilation passage is provided at the designated divided surface forming the divided surface.

4. The powder molding apparatus according to claim 1,
wherein the defining surface of each of the plurality of divided dies comprises a shape according to the shape of the side surface of the powder molded body, the side surface comprising:
an obtuse surface intersecting a reference horizontal plane at an obtuse angle; and
an acute surface intersecting the reference horizontal plane at an acute angle,
the side surface comprising a boundary part between at least one surface of the obtuse surface and the acute surface and a surface adjacent to the at least one surface, and at least a part of the boundary part is inclined with respect to the refer horizontal plane, and
the designated divided surface forming the divided surface of the plurality of divided dies extends along the boundary part of the powder molded body.

5. The powder molding apparatus according to claim 1,
wherein a projection is provided so as to project from the defining surface of at least one divided die of the plurality of divided dies in a direction perpendicular to the translational direction of the at least one divided die and is configured to form a recess or a through hole at the powder molded body.

6. A method for preparing a powder molded body, the method being for preparing the powder molded body by using a plurality of divided dies configured to relatively translate and abut against each other so as to form a cavity according to a shape of a side surface of the powder molded body,
each of the plurality of divided dies comprising:
a defining surface configured to define the cavity; and
a divided surface, the divided surface comprising:
a designated divided surface constituted by at least one of an inclined divided surface inclined with respect to a translational direction of each of the plurality of divided dies and a parallel divided surface parallel to the translational direction; and
at least one pair of perpendicular divided surfaces disposed on an opposite side based on the defining surface, the at least one pair of perpendicular divided surfaces being perpendicular to the translational direction,
wherein each of the plurality of divided dies, while abutting against each other at the at least one pair of perpendicular divided surfaces of the divided surface, abuts against each other in a state of being spaced apart from each other with a gap within a range of 1 to 30 μm at the inclined divided surface, thereby forming the cavity.

7. A die comprising a plurality of divided dies configured to relatively translate and abut against each other so as to form a cavity according to a shape of a side surface of a powder molded body or a shape of a side surface of a sintered body,
each of the plurality of divided dies comprising:
a defining surface configured to define the cavity; and
a divided surface, the divided surface comprising:
a designated divided surface constituted by at least one of an inclined divided surface inclined with respect to a translational direction of each of the plurality of divided dies and a parallel divided surface parallel to the translational direction; and
at least one pair of perpendicular divided surfaces disposed on an opposite side based on the defining surface, the at least one pair of perpendicular divided surfaces being perpendicular to the translational direction,
wherein each of the plurality of divided dies, while abutting against each other at the at least one pair of perpendicular divided surfaces of the divided surface, abuts against each other in a state of being spaced apart from each other with a gap within a range of 1 to 30 μm at the inclined divided surface, thereby forming the cavity.
